(19) United States
(12) Patent Application Publication
(10) Pub. No.: US 2001/0003354 A1
(43) Pub. Date: Jun. 14, 2001

(54) Garden hose sidewall support apparatus

(76) Inventor: Hencia Cockayne, Clearwater, FL (US)

Correspondence Address: John D. Gugliotta, P.E., Esq., Law Offices, 202 Delaware Building, 137 South Main Street, Akron, OH, 44308, US

(21) Appl. No.: 09/732,172

(22) Filed: Dec. 7, 2000

Related U.S. Application Data
(63) Continuation-in-part of application No. 09/456,051, filed on Dec. 7, 1999, now abandoned.

(51) Int. Cl. A62C 13/76

(52) U.S. Cl. 248/75

(57) ABSTRACT

An apparatus is provided formed of a pair of opposed, spring urged comb members that is intended to slip over the area subject to kinking and keeps it in a straight position to allow water to flow.

### RELATED APPLICATIONS

The present invention was is a Continuation in Part of U.S. patent application Ser. No. 09/456,051, filed on Dec. 07, 1999, and herein abandoned.

### BACKGROUND OF THE INVENTION

1. Field of the Invention

The present invention relates generally to devices for preventing hoses from kinking and the like and, more particularly, to a device for attachment to the outer wall of a conventional garden hose to prevent kinking.

2. Description of the Related Art

In the related art, there are a wide variety of products aimed at providing a convenient means by which to water one's garden. In light of all of these competing methods and devices, the common factor to all of them is the use of a garden hose. However, the common garden hose is subject to many problems such as leaking, difficulty in removing and attaching the hose to a spigot, and so forth. But by far the biggest aggravation is kinking of the garden hose. It may kink when it is routed over a sharp corner of the house or a step. It may also kink when a door or garage door is closed upon it. Or, in the case of an older, worn hose, it may simply repeatedly kink at a weak spot.

Numerous attempts have been made to correct for the foregoing problems. The following patents disclose a kink-resistant hose liner:

U.S. Pat. No. 5,682,925 issued in the name of Seckel;

U.S. Pat. No. 5,573,039 issued in the name of Mang;

U.S. Pat. No. 5,315,748 issued in the name of Seckel;

U.S. Pat. No. 5,062,456 issued in the name of Cooke et al.;

U.S. Pat. No. 4,923,223 issued in the name of Seckel; and

U.S. Pat. No. 4,867,485 issued in the name of Seckel.

U.S. Pat. No. 5,857,711 issued in the name of Comin-DuMong et al. describes a hose sleeve to prevent the length of hose from kinking.

U.S. Pat. No. 4,805,933 issued in the name of Swisher discloses a hose end sleeve for receiving a coupling nut.

U.S. Pat. No. 3,985,167 issued in the name of Roque describes a dual hose arrangement that is rotatable, thereby precluding kinking of the hoses.

While adjustable window coverings are incorporated into this invention as well as in other related references, other elements in combination are different enough as to make the combination distinguished over these related references.

Consequently, a need has therefore been felt a means by which a garden hose may be prevented from kinking and thus avoiding an interruption in water flow.

### SUMMARY OF THE INVENTION

Therefore, it is an object of the invention to indicate a device of the type disclosed above which avoids the disadvantages inherent in the state of the art. In particular, it is an object of the present invention to provide an improved garden hose sidewall support apparatus.

It is a feature of the present invention to provide an improved garden hose sidewall support apparatus that fits over the outer sidewall of any conventional garden hose in order to provide resistance to collapse and kinking of the hose sidewall.

Briefly described according to the preferred embodiment of the present invention, is an apparatus that prevents a garden hose from kinking. It is intended to slip over the area subject to kinking and keeps it in a straight position to allow water to flow. It can be utilized on worn hoses that have a weak spot where they repeatedly kink time after time. It can also be used where the routing of the garden hose takes it around a sharp corner or under a garage door. The use of the invention gives new life to old, worn hoses, thus saving money. It also protects new hoses and saves them from harm. The reduction in kinking tendencies also makes the job of coiling the hose up after use easier as well.

The use of the present invention eliminates the aggravation that arises when using a garden hose that constantly kinks in a certain location.

Advantages of the present invention is that the devise prevents hose kinking, protects hoses over sharp corners, protects hoses under garage doors, and adds new life to hoses that repeatedly kink at a certain spot.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of garden hose sidewall support apparatus according to the preferred embodiment of the present invention;

FIG. 2 is a top plan view thereof;

FIG. 3 is a front elevational view thereof;

FIG. 4 is a cross sectional view thereof shown taken along the linear longitudinal centerline thereof; and

FIG. 5 is a perspective view of the present invention shown in use with a conventional garden hose.

### DESCRIPTION OF THE PREFERRED EMBODIMENTS

1. Detailed Description of the Figures

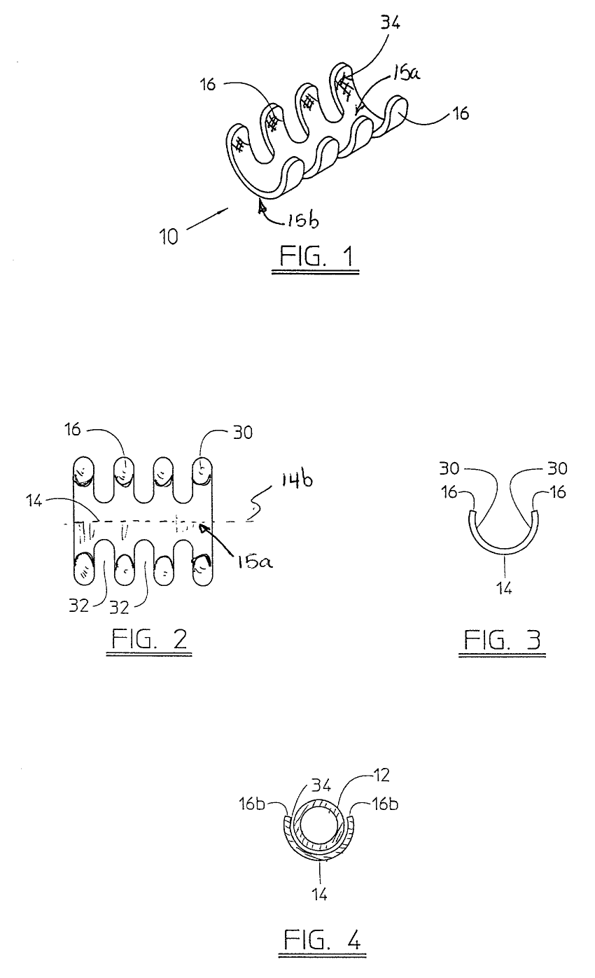

Referring now to FIGS. 1-5, a garden hose sidewall support apparatus 10 is shown, according to the present invention, for use with an otherwise conventional garden hose 12. The apparatus 10 is formed as a generally elongated support spine member 14 being generally elongated about a lateral spine centerline 14b. The spine member 14, being elongated, forms a flat inner surface 15a opposite a flat outer surface 15b. The spine member 14 itself is formed of a rigid material capable of being deformable in a direction perpendicular to the spine centerline 14b such as, when deformed, a spring urging bias is created toward the inner surface 15a or outer surface 15b. Extending laterally outward from both sides of the spine centerline 14b are a series of opposed detentes 16 extending outward from the spine member 14 along each side of the linear length. The detentes 16 are each formed of a plurality of sidewall support combs 16b curve upward toward the upper surface 15a. The opposed detentes 16 are curved such as to form a retaining arc slightly greater than a semicircle. In this fashion, the detentes 16 can partially circumscribe about the outer sidewall of a conventional garden hose 12 as described in greater detail below.

In detail, the detentes 16 are each formed by a plurality of contact elements 30 separated by a spaced distance 32 separating each pair of adjacent contact elements 30. On the internal surface of each contact element 30 is further formed an internal gripping surface 34 that allows the contact points between the detentes 16 and the outer sidewall of the hose 12. In this manner, when the spine member 14 is aligned with the hose 12 and detentes 16 annularly circumscribed about the hose 12 the apparatus 10 can be placed and held into a particular position relative to the length of the hose 12 itself.

2. Operation of the Preferred Embodiment

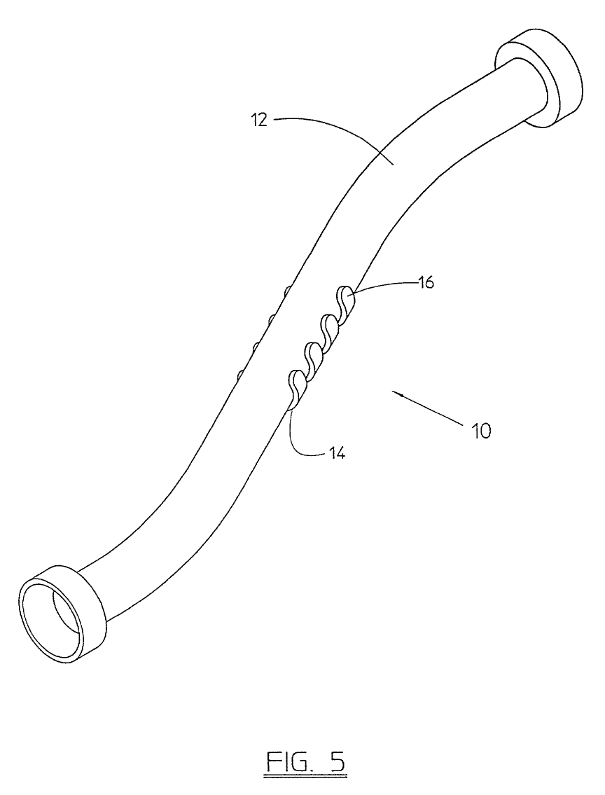

In accordance with a preferred embodiment of the present invention, as shown in FIG. 5, the present invention is intended to slip over the area subject to kinking and keeps it in a straight position to allow water to flow. The spring urging force retains the apparatus against the hose outer sidewall, and can be utilized on worn hoses that have a weak spot where they repeatedly kink time after time. It can also be used where the routing of the garden hose takes it around a sharp corner or under a garage door. The use of the invention gives new life to old, worn hoses, thus saving money. It also protects new hoses and saves them from harm. The reduction in kinking tendencies also makes the job of coiling the hose up after use easier as well.

As designed, a device embodying the teachings of the present invention is easily applied. The foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. Therefore, the scope of the invention is to be broadly limited only by the following claims.

What is claimed is:

1. A garden hose sidewall support apparatus for use with an otherwise conventional garden hose, said apparatus comprising:
a generally elongated support spine member being generally elongated about a lateral spine centerline forming a flat inner surface opposite a flat outer surface, said spine member formed of a rigid material capable of being deformable in a direction perpendicular to said spine centerline; and
a series of opposed detentes extending laterally outward from both sides of said spine centerline extending outward from the spine member along each side of the linear length, said detentes forming a pair of opposed sidewall support combs curved such as to form a retaining arc slightly greater than a semicircle.

2. The garden hose sidewall support apparatus of claim 1, wherein said detentes are each formed by a plurality of contact elements separated by a spaced distance separating each pair of adjacent contact elements.

3. The garden hose sidewall support apparatus of claim 2, further comprising an internal gripping surface on the internal surface of each contact element.

4. The garden hose sidewall support apparatus of claim 1, wherein when said support spine is deformed, a spring urging bias is created toward said inner surface or said outer surface.

5. A garden hose sidewall support apparatus for use with an otherwise conventional garden hose, said apparatus comprising:
a first sidewall support comb, said first sidewall support comb formed of a series of parallel detentes curved such as to form a first retaining arc;
a second sidewall support comb, said second sidewall support comb formed of a series of parallel detentes curved such as to form a second retaining arc;
a generally elongated support spine member being generally elongated and having a first lateral side opposite a second lateral side about a lateral spine centerline and having said first sidewall support comb affixed to said first lateral side and said second sidewall support comb affixed to said second lateral side such that said support combs combined curve such as to form a retaining arc slightly greater than a semicircle.

6. The garden hose sidewall support apparatus of claim 5, wherein said spine member formed of a rigid material capable of being deformable in a direction perpendicular to said spine centerline such that when said support spine is deformed, a spring urging bias is created.

7. The garden hose sidewall support apparatus of claim 5, wherein said detentes are each formed by a plurality of contact elements separated by a spaced distance separating each pair of adjacent contact elements.

8. The garden hose sidewall support apparatus of claim 7, further comprising an internal gripping surface on the internal surface of each contact element.
